(19) United States
(12) Patent Application Publication
(10) Pub. No.: US 2017/0320375 A1
(43) Pub. Date: Nov. 9, 2017

(54) ENERGY RECOVERY SYSTEM FOR TAPPING THERMAL ENERGY FROM A MEDIUM CONTAINING HEAT ENERGY

(71) Applicant: Gentherm GmbH, Odelzhausen (DE)

(72) Inventors: Martin Krobok, Aichach (DE); Marco Ranalli, Augsburg (DE); Sheila Waliño Ariete, Augsburg (DE)

(21) Appl. No.: 15/524,734

(22) PCT Filed: Nov. 5, 2015
(86) PCT No.: PCT/DE2015/000533

§ 371 Date: May 5, 2017

(30) Foreign Application Priority Data
Nov. 7, 2014 (DE) 10 2014 016 390.3

(51) Int. Cl. B60H 1/20; F01N 5/02; B60H 1/04

(52) U.S. Cl. CPC B60H 1/20; B60H 1/04; F01N 5/02

(57) ABSTRACT

The present invention relates to an energy recovery system (51), which withdraws heat from a feed medium (52) containing heat energy, and—which has a heat transfer system (53) for this purpose, in order to transfer heat energy from the feed medium to a useful medium (54). According to the invention—the heat transfer system (53) has a separation system (57) which spaces apart the two media (52, 54); the heat transfer system (53) has at least one first exchanger zone (35), which allows the transfer of heat from the feed medium (52) to the useful medium (54) as long as the temperature of the feed medium is higher than that of the useful medium (54, 54′); and—the heat transfer system (53) has at least one second exchanger zone (56), which allows the transfer of heat from the feed medium (54, 54′), even when the temperature of the feed medium is lower than that of the useful medium.

The present invention relates to an energy recover system for tapping thermal energy from a medium containing heat energy, according to the features of the preamble of claim 1. The energy recovery system withdraws heat from a feed medium which bears heat energy, by means of a heat transfer device, whereby heat is transferred from the feed medium to a useful medium.

In many instances, energy recovery systems of the described general type are employed in order to save energy. However, energy recovery systems known from the prior art are generally very expensive, and often they operate satisfactorily only in narrow temperature ranges, being essentially useless in other temperature ranges.

Accordingly, the object of the invention was to devise an energy recovery system which at least partially avoids the drawbacks of the prior art, and which reliably operates over broad temperature ranges and not merely over narrow temperature ranges.

To achieve this object, the present invention proposes an energy recovery system which taps heat from a feed medium which bears thermal energy, which system has a heat transfer system for this purpose, in order to transfer heat energy from the feed medium to a useful medium. The heat transfer system has a separation system which spaces apart the feed medium and the useful medium. The heat transfer system also has at least one first exchanger zone which allows the transfer of heat from the feed medium to the useful medium as long as the temperature of the feed medium is higher than that of the useful medium. In addition, the heat transfer system has at least one second exchanger/one which allows transfer of heat from the feed medium to the useful medium, even when the temperature of the feed medium is lower than that of the useful medium.

This scheme allows efficient transfer of energy from the feed medium to the useful medium over a wide range of temperatures. In the event that the temperature difference between the two media is relatively high, the heat can be transferred readily and in simple fashion by heat conduction. If the temperature difference is small, or if the feed medium is colder than the useful medium, heat can still be transferred efficiently from the feed medium to the useful medium.

Is has also been found to be advantageous if the first exchanger zone does not have a heat pump, and the second exchanger zone is equipped with at least one heat pump. This facilitates the transfer of heat from the feed medium to the useful medium.

As described above, it is provided that the energy recovery system taps heat from a feed medium which bears thermal energy, which system has a heat transfer system for this purpose, in order to transfer heat energy from the feed medium to a useful medium. Toward this end, the heat transfer system may have an exchanger zone, in which the feed medium and the useful medium are spaced apart by means of a separation system. In this connection, the heat transfer system has at least one operating state, in which the separation system allows a transfer of heat from the feed medium to the useful medium by simple heat conduction, as long as the temperature of the feed medium is higher than that of the useful medium. Additionally, the heat transfer system has at least one second operating state, in which state a heat pump is switched on, in order to transfer heat from the feed medium to the useful medium, when the temperature of the feed medium is lower than that of the useful medium. This manner of operation allows the energy recovery system to efficiently adapt to a variety of operating conditions with only a single heat pump.

Ideally, the at least one heat pomp has at least one of the following components: a thermoelectric device, a Peltier element, or a compressor.

For the feed medium, in particular at least one of the following is provided as a component of the medium: air leaving a vehicle cabin, exhaust gas from an internal combustion engine, heated cooling water from an engine cooling system, or air drawn from a building or the like or from parts of a building or the like.

The heat transfer system may have at least one first heat exchanger and a second heat exchanger, and may also have a first flow path wherein the feed medium in its passage through the heat, transfer system is passed through the first heat exchanger and the second heat exchanger. In this connection, it may be provided that only the second heat exchanger is equipped with a beat pump, and said second heat exchanger, which has a heat pump, is disposed downstream of the first heat exchanger, which does not have a heat pump.

It may be further provided that the heat transfer system has a second flow path wherein the useful medium in its passage through the heat transfer system is passed through the first heat exchanger and the second heat exchanger, In this connection it is advantageous of the second heat exchanger, which has a heat pump, is disposed downstream of the first heat exchanger, which does not have a heat pump.

Through these variant embodiments, when the temperature difference between the feed medium and the useful medium is relatively high, the heat can be transferred by simple heat conduction, in the conventional first heat exchanger.

As a further component of the invention, the heat transfer system may have at least one fluid circulation loop, in which a first useful medium is provided for circulation. In addition, at least one third heat exchanger may be provided, which on one side is influenced by the first useful medium and which on the other side is influenced by a second useful medium. In order to be able to transfer heat from the first useful medium to the second useful medium.

Ideally, the first useful medium has at least one of the following components: water, alcohols, ethanol, and ethylene glycol. The second useful medium may have at least one of the following components: air, heat transfer medium for a heating device, and fresh air destined for a vehicle cabin.

Additionally, the invention relates to a ventilation system comprised of an inventive energy recovery system. The ventilation system may be implemented is one of the following systems: a vehicle, a structure, an automobile, or a room. The invention may also comprise a vehicle and/or structure which is equipped with an inventive ventilation system. Particular when the invention is employed in an electrically powered vehicle in which, experience demonstrates, there is often a deficiency of available energy, an appreciable amount of energy can be saved by such an energy recovery system.

Hereinbelow, features of the invention will be described in some detail. This will be done with reference to embodiments intended to make the invention more understandable. However, the embodiments only have the nature of exemplary embodiments. It should be obvious that one or more described features can be modified, supplemented, or omitted, all within the scope of the invention as set forth in the independent claims. It should further be obvious that features of various embodiments may be combined. The decisive factor is that the underlying concept of the invention is implemented. If a feature is at least partially to be realized, it is within the scope of the invention for the feature to be completely or essentially completely realized. The term “essentially” means here in particular that the use and advantage sought to be provided is realized to a recognizable extent. It may mean in particular that the feature is realized to the extent of 50%, 90%, 95%, or 99%. If a minimum quantity is recited, it should be obvious that more than the stated quantity may be employed. If a minimum number of instances of a component is recited, the intended scope encompasses embodiments having two, three, or another number of instances of the component. A description applicable to a given object may also be applied to the predominant part or the totality of all other similar objects. Unless otherwise specified, intervals include their end points. The word “a” or “an” hereinbelow is intended as an indefinite article, and may signify “a”, “an”, “one”, “a single”, or “at least one”.

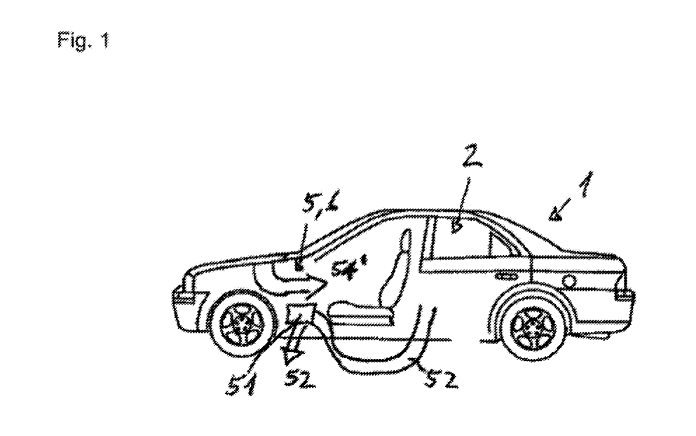

FIG. 1 is a schematic representation of a vehicle with an inventive energy recovery system; and

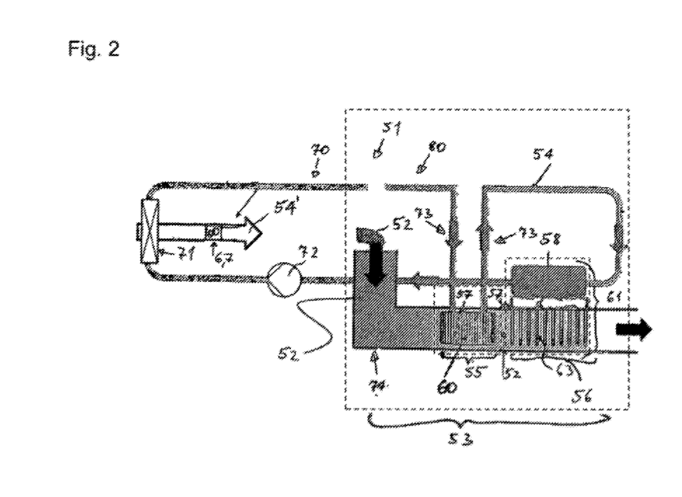

FIG. 2 is a schematic representation of an inventive energy recovery system.

FIG. 1 depicts a vehicle 1 which has been provided with an inventive energy recovery system 51. Vehicles 1, the group of which includes in particular devices for transportation of persons or goods, such as land, water, rail, or air vehicles, particularly motor-driven aircraft, ships, or automobiles, are ordinarily equipped with climatization systems. The climatization system 5 comprises in particular a device which is suitable for influencing a controlled system or process as to at least one climatization parameter. In this connection, it is sought to bring the parameter(s) for at least a brief period to a particular set-point value or into a particular desired range of values; and/or to so maintain the parameter(s) over an extended period of time. The processes involved include temperature regulation, ventilation, humidification, dehumidification, and/or climatization. Such a climatization system is particularly suited for temperature control or climatization of, e.g., a vehicle seat during a long automobile trip, or for pre-adjustment of the temperature of a fuel.

Typically, the climatization system 5 is further comprised of at least one ventilation system 6. This ventilation system is comprised, of, in particular, a device which can be employed to control the air composition or air flows in a particular area, e.g. in an onboard HVAC system of a vehicle, or in spacing media, spacing fabric items, and/or climatization inserts. This allows ventilation of at least one “object of climate control” 2, in particular for dehumidifying or temperature controlling of a surface of an “object of climate control” 2 which surface is close to or is contacted by persons.

Advantageously, the at least one ventilation system 6 has at least one air advancing device. The term “air advancing device” includes, in particular, a device for moving air. Examples of such devices are axial blowers and radial fans.

FIG. 2 illustrates an energy recovery system 51 according to the invention. The system 51 is provided for the purpose of tapping heat from a feed medium 52 which contains thermal energy. For this purpose, the energy recovery system 51 is comprised of a heat transfer device 53. This heat transfer device 53 is designed to be capable of transferring thermal energy from the feed medium 52 to a useful medium 54. The feed medium 52 may be comprised of, at least to some extent, air which is leaving a vehicle cabin, exhaust gas from an internal combustion engine, heated cooling water from an engine cooling system, or air from a building. The components of the useful medium 54 may comprise, in particular, water, ethylene glycol, alcohols, or ethanol. For ideal circulation, a fluid circulation loop 80 is provided for the useful medium 54.

For optimal operation, the heat transfer device 53 has a “separation system” 57 which is provided in order to keep the feed medium 52 aid the useful medium 54 separate from each other. In a first exchanger zone 55, heat can be transferred from the feed medium 52 to the useful medium 54, provided that the temperature T_{S} of the feed medium 52 is higher than the temperature T_{N} of the useful medium 54. A second exchanger zone 56 is provided in the heat transfer device 53 for enabling heat transfer from the feed medium 52 to the useful medium 54 when the temperature T_{S} of the feed medium 52 is lower than the temperature T_{N} of the useful medium 54. The second exchanger zone 56 has at least one heat pump 58, for enabling heat transfer from the feed medium 52 to the useful medium 54 even when the temperature T_{S} of the feed medium 52 is lower than the temperature T_{N} of the useful medium 54. Ordinarily, the first exchanger zone 55 will not have a heat pump 58, because here simple heat transfer from the feed medium 52 to the useful medium 54 will occur, under conditions of the temperature T_{S} of the feed medium 52 being higher than the temperature T_{N} of the useful medium 54.

The heat transfer device 53 may have at least one first operating stale, in which the “separation system” 57 allows transfer of heat from the feed medium 52 to the useful medium 54 by simple heat conduction, as long as the temperature T_{S} of the feed medium 52 is higher than the temperature T_{N} of the useful medium 54. The heat transfer device 53 may also have at least one second operating state, in which the heat pump 58 is switched on, in order to transfer heat from the feed medium 52 to the useful medium 54 under circumstances where die temperature T_{S} of the teed medium 52 is lower than the temperature T_{N} of the useful medium 54.

The heat transfer device 53 may further be comprised of at least one first heat exchanger 60 and a second heat exchanger 61. With this arrangement, the first heat exchanger 60 is associated with the first exchanger zone 55, and the second heat exchanger 61 is associated with the second exchanger zone 56. The useful medium 54 flows in a first flow path 70, and the feed medium 52 flows in a second flow path 74; these paths, separated by the separation system 57, extend through the heat transfer device 53 and the first and second exchanger zones 55, 56. The feed medium 52, in passing through the heat transfer device 53, is passed along the second flow path 74, through the first and second heat exchangers 60, 61. The useful medium 54, for its part, is passed along the second flow path 70, also through the first and second heat exchangers 60, 61 of the heat transfer device 53. In the first exchanger zone 55, heat is passed from the feed medium 52 to the useful medium 54 by heat conduction, as long as the temperature T_{S} of the feed medium 52 is higher than the temperature T_{N} of the useful medium 54. By means of a heat transfer body 63, disposed at least partially in the second flow path 74 in the region of the second exchanger zone 56, heat can be received from the feed medium 52, particularly under circumstances where the temperature T_{S} of the feed medium 52 is lower than the temperature T_{N} of the useful medium 54, and such heat can be transferred to the useful medium 54, by means of the heat pump.

The direction of advance in the first flow path 70 can be maintained in the flow direction (arrow 73) with the aid of a fluid advancing device 72. With this arrangement it is provided in particular that the second heat exchanger 61, which comprises a heat pump 58, is disposed downstream in the flow direction relative to the first heat exchanger 60, which does not comprise a heat pump 58. In many cases it may thus be possible to further utilize the thermal energy of the feed medium 52, which has already undergone cooling by way of the first heat exchanger 60, namely to utilize such energy for heat transfer, by means of the second heat exchanger 61, which has a heat pump 58 for purposes of heat transfer.

Additionally, a third heat exchanger 71 may be provided, in the fluid circulation loop 80 of the useful medium 54. Under this arrangement, the third heat exchanger 71 is influenced on one side by the first useful medium 54 and on the other side by a second useful medium 54′. It is intended for heat to be transferred from the first useful medium 54 to the second useful medium 54′. The second useful medium 54′ is comprised at least partially of air, or a heat transfer medium of a heating device, or even fresh air destined for a vehicle cabin. With the aid of the ventilation system 6 or the air advancing device 7, the now temperature-adjusted useful medium 54′ can be conveyed to its intended [functional] destination.

### LIST OF REFERENCE NUMERALS

1 Vehicle.

2 Object of climate control.

5 Climatization system.

6 Ventilation system.

7 Air advancing device.

51 Energy recovery system.

52 Feed medium.

53 Heat transfer device (also referred to as “heat transfer system”).

54, 54′ Useful medium.

55, 56 Exchanger zone.

57 Separation system.

58 Heat pump.

60, 61, 71 Heat exchanger.

63 Heat transfer body, ribbed.

70, 74 Flow path.

12 Fluid advancing device.

73 Flow direction.

80 Fluid circulation loop.

1. An energy recovery system comprising:
a heat transfer system that transfers heat energy from a feed medium to a useful medium, the energy recovery system tapping heat from the feed medium which contains thermal energy;
wherein:
the heat transfer system has a separation system which spaces apart the two media;
the heat transfer system has at least one first exchanger zone;
which first exchanger zone allows the transfer of heat from the feed medium to the useful medium as long as a temperature of the feed medium is higher than that of the useful medium; and in that
the heat transfer system has at least one second exchanger zone;
which second exchanger zone allows transfer of heat from the feed medium to the useful medium, even when the temperature of the feed medium is lower than that of the useful medium.

2. The energy recovery system according to claim 1; wherein the first exchanger zone does not have a heat pump, and the second exchanger zone is equipped with at least one heat pump.

3. An energy recovery system comprising:
a heat transfer system that transfers heat energy from a feed medium to a useful medium, the energy recovery system tapping heat from the feed medium which contains thermal energy;
wherein
the heat transfer system has an exchanger zone, in which zone the two media are spaced apart by means of a separation system; further in that the heat transfer system has at least one first operating state;
in which first state the separation system allows a transfer of heat from the feed medium to the useful medium by simple heat conduction, as long as the temperature of the feed medium is higher than that of the useful medium;—and in that
the heat transfer device has at least one second operating state;
in which second state a heat pump is switched on, in order to transfer heat from the feed medium to the useful medium, when the temperature of the feed medium is lower than that of the useful medium.

4. The energy recovery system according to claim 2;
wherein at least one heat pump has at least one of the following components: a thermoelectric device, a Peltier element, or a compressor.

5. The energy recovery system according to claim 1;
wherein—the feed medium has at least one of the following components:—air leaving a vehicle cabin, exhaust gas from an internal combustion engine, heated cooling water from an engine cooling system, or air drawn from a building or the like or from parts of a building or the like.

6. The energy recovery system according to claim 1;
wherein
the heat transfer device has at least one first heat exchanger and a second heat exchanger;—further in that
the heat transfer device has a flow path wherein the feed medium while passing through the heat transfer device is passed through two heat exchangers;—further in that
only the second of the two heat exchangers is equipped with a heat pump;—and in that
the heat exchanger having a heat pump is disposed downstream of the first heat exchanger not having a heat pump.

7. The energy recovery system according to claim 3;
wherein:
the heat transfer device has a flow path wherein the useful medium while passing through the heat transfer device passed through two heat exchangers;—and in that
the heat exchanger having a heat pump is disposed downstream of the first heat exchanger not having a heat pump.

8. The energy recovery system according to claim 1;
wherein—the heat transfer device has:
at least one fluid circulation loop, in which a first useful medium is provided for circulation; and
at least one third heat exchanger which on one side is influenced by the first useful medium and which on the other side is influenced by a second useful medium, in order to transfer heat from the first useful medium to the second useful medium.

9. The energy recovery system according to claim 1;
wherein the first useful medium has at least one of the following components:—water, alcohols, ethanol, and ethylene glycol.

10. The energy recovery system according to claim 1;
wherein—the second useful medium has at least one of the following components:—air, heat transfer medium for a heating device, and fresh air destined for a vehicle cabin.

11. A ventilation system equipped with an energy recovery system according to claim 1.

12. The ventilation system according to claim 11; wherein the ventilation system is implemented in one of the following systems:—a vehicle, a building or the like, an automobile, or a room.

13. A vehicle having a ventilation system according to claim 11.

14. A building having a ventilation system according to claim 11.

15. The energy recovery system according to claim 3; wherein at least one heat pump has at least one of the following components: a thermoelectric device, a Peltier element, or a compressor.

16. The energy recovery system according to claim 3; wherein the first useful medium has at least one of the following components: water, alcohols, ethanol, and ethylene glycol.

17. The energy recovery system according to claim 3; wherein the second useful medium has at least one of the following components: air, heat transfer medium for a heating device, and fresh air destined for a vehicle cabin.

18. The energy recovery system according to claim 3; wherein the feed medium has at least one of the following components: air leaving a vehicle cabin, exhaust gas from an internal combustion engine, heated cooling water from an engine cooling system, or air drawn from a building or the like or from parts of a building.
